(19) United States
(12) Patent Application Publication
(10) Pub. No.: US 2021/0232926 A1
(43) Pub. Date: Jul. 29, 2021

(54) MAPPING IMAGES TO THE SYNTHETIC DOMAIN

(71) Applicant: SIEMENS AKTIENGESELLSCHAFT, München (DE)

(72) Inventors: Andreas Hutter, München (DE); Slobodan Ilic, München (DE); Benjamin Planche, Princeton, NJ (US); Ziyan Wu, Lexington, MA (US); Sergey Zakharov, Kirchseeon (DE)

(21) Appl. No.: 17/268,675

(22) PCT Filed: Aug. 12, 2019
(86) PCT No.: PCT/EP2019/071604

§ 371 Date: Feb. 16, 2021

Related U.S. Application Data
(60) Provisional application No. 62/719,210, filed on Aug. 17, 2018.

(30) Foreign Application Priority Data
Nov. 28, 2018 (EP) 18208941.7

(51) Int. Cl. G06N 3/08; G06K 9/62

(52) U.S. Cl. CPC G06N 3/08; G06K 9/6256; G06K 9/6232

(57) ABSTRACT

A method for training a generative network that is configured for converting cluttered images into a representation of the synthetic domain and a method for recovering an object from a cluttered image.

### CROSS REFERENCE TO RELATED APPLICATIONS

This present patent document is a § 371 nationalization of PCT Application Serial Number PCT/EP2019/071604 filed on Aug. 12, 2019, designating the United States, which is hereby incorporated in its entirety by reference. This patent document also claims the benefit of U.S. 62/719,210 filed on Aug. 17, 2018 and EP 18208941.7 filed on Nov. 28, 2018 both are which are also hereby incorporated in their entirety by reference.

### FIELD

Embodiments relates to a method for training a generative network that is configured for converting cluttered images into a representation of the synthetic domain, for example normal maps. The trained generation network may be used for recognizing an object or its properties from a noisy color image.

### BACKGROUND

The generative network includes an artificial neural network. Deep convolutional neural networks are suited for this task. The ever-increasing popularity of deep convolutional neural networks seems well-deserved, as deep convolutional neural networks are adopted for more and more complex applications. This success has to be slightly nuanced though, as the methods usually rely on large annotated datasets for their training. In many cases still (for example for scalable industrial applications), it might be extremely costly, if not impossible, to gather the required data. For such use-cases and many others, synthetic models representing the target elements are however usually pre-available. Examples of such synthetic models are industrial three-dimensional (3D) computer-aided design (CAD) blueprints, simulation models, etc. It thus became common to leverage such data to train recognition methods for example by rendering huge datasets of relevant synthetic images and their annotations.

However, the development of exhaustive, precise models behaving like their real counterparts is often as costly as gathering annotated data (for example acquiring precise texture information, to render proper images from CAD data, actually imply capturing and processing images of target objects). As a result, the salient discrepancies between model-based samples and target real ones (known as “realism gap”) still heavily impairs the application of synthetically-trained algorithms to real data. Research in domain adaptation thus gained impetus the last years.

Several solutions have been proposed, but most of them require access to real relevant data (even if unlabeled) or access to synthetic models too precise for scalable real-world use-cases (for example access to realistic textures for 3D models).

The realism gap is a well-known problem for computer vision methods that rely on synthetic data, as the knowledge acquired on the modalities usually poorly translates to the more complex real domain, resulting in a dramatic accuracy drop. Several ways to tackle this issue have been investigated so far.

A first proposal is to improve the quality and realism of the synthetic models. Several works try to push forward simulation tools for sensing devices and environmental phenomena. State-of-the-art depth sensor simulators work fairly well for instance, as the mechanisms impairing depth scans have been well studied and may be rather well reproduced, as for example published by Planche, B., Wu, Z., Ma, K., Sun, S., Kluckner, S., Chen, T., Hutter, A., Zakharov, S., Kosch, H. and Ernst, J.: “DepthSynth: Real-Time Realistic Synthetic Data Generation from CAD Models for 2.5D Recognition”, Conference Proceedings of the International Conference on 3D Vision, 2017. In case of color data however, the problem does not lie in the sensor simulation but in the actual complexity and variability of the color domain (for example sensitivity to lighting conditions, texture changes with wear-and-tear, etc.). This makes it extremely arduous to come up with a satisfactory mapping, unless precise, exhaustive synthetic models are provided (for example by capturing realistic textures). Proper modelling of target classes is however often not enough, as recognition methods might also need information on their environment (background, occlusions, etc.) to be applied to real-life scenarios. For this reason, and in complement of simulation tools, recent CNN-based methods are trying to further bridge the realism gap by learning a mapping from rendered to real data, directly in the image domain. Mostly based on unsupervised conditional generative adversarial networks (GANs) or style-transfer solutions, these methods still need a set of real samples to learn their mapping.

Other approaches are instead focusing on adapting the recognition methods themselves, to make them more robust to domain changes. There exist, for instance, solutions that are also using unlabeled samples from the target domain along the source data to teach the task-specific method domain-invariant features. Considering real-world and industrial use-cases when only texture-less CAD models are provided, the lack of target domain information may also be compensated by training their recognition algorithms on heavy image augmentations or on a randomized rendering engine. The claim is that with enough variability in the simulator, real data may appear just as another variation to the model.

### BRIEF SUMMARY AND DESCRIPTION

The scope of the present invention is defined solely by the appended claims and is not affected to any degree by the statements within this summary. The present embodiments may obviate one or more of the drawbacks or limitations in the related art.

Embodiments provide an alternative concept how to bridge the realism gap. A method is provided for how to train a generative network to accurately generate a representation of the synthetic domain, for example a clean normal map, from a cluttered image.

Embodiments provide a method for training a generative network that is configured for converting cluttered images from the real domain into a representation of the synthetic domain. In addition, embodiments provide a method for recovering an object from a cluttered image. In the following, first the training method for the generative network is described in detail; subsequently, the method for object recovery is dealt with.

The generation network (note that the terms “generative network” and “generation network” are used interchangeably throughout this application) that is configured for converting cluttered images into representations of the synthetic domain includes an artificial neural network. The method of training the generation network includes the following steps:

Receiving a cluttered image as input;

Extracting a plurality of features from the cluttered image by an encoder sub-network;

Decoding the features into a first modality by a first decoder sub-network;

Decoding the features into at least a second modality, that is different from the first modality, by a second decoder sub-network;

Correlating the first modality and the second modality by a distillation sub-network; and

Returning a representation of the synthetic domain as output.

Notably, the artificial neural network of the generation network is trained by optimizing the encoder sub-network, the first decoder sub-network, the second decoder sub-network and the distillation sub-network together.

Artificial neural networks (ANN) are computing systems vaguely inspired by the biological neural networks that constitute animal brains. Artificial neural networks “learn” to perform tasks by considering examples, generally without being programmed with any task-specific rules.

An ANN is based on a collection of connected units or nodes called artificial neurons that loosely model the neurons in a biological brain. Each connection, like the synapses in a biological brain, may transmit a signal from one artificial neuron to another. An artificial neuron that receives a signal may process it and also generate additional artificial neurons connected to it.

In common ANN implementations, the signal at a connection between artificial neurons is a real number, and the output of each artificial neuron is computed by some non-linear function of the sum of its inputs. The connections between artificial neurons are called “edges”. Artificial neurons and edges typically have a weight that adjusts as learning proceeds. The weight increases or decreases the strength of the signal at a connection. Typically, artificial neurons are aggregated into layers. Different layers may perform different kinds of transformations on their inputs. Signals travel from the first layer (the input layer) to the last layer (the output layer), oftentimes passing through a multitude of hidden layers in-between.

A “cluttered” image of an object is understood as an image wherein some kind of disturbance, in other words nuisance, has been added to. The “clutter” includes, but is not limited to, a background behind the object, shading, blurring, rotating, translating, flipping and resizing of the object, and partial occlusions of the object.

In the case that the input representation is not textured or colored—for example in the case of a texture-less CAD model —, then random surface texture, and color may be added to the input representation in the sense of clutter, too, respectively.

Images, as well as depth or normal maps, may in principle either be based on a real photo or the images may be generated synthetically from models such as computer-aided design (CAD) models. In addition, the clutter may either be the result of a real photograph of the object taken with for example some background behind and partly occluded or may be generated artificially. A representation (for example, an image, a depth map, a normal map, etc.) is referred to as “clean” if it does not contain any clutter.

The encoder sub-network and the decoder sub-network may be referred to as the “encoder” and the “decoder”, respectively.

There are many ways to represent an object. For instance, the object may be represented by a depth map. Each point (pixel) of the depth map indicates its distance relative to a camera.

The object may also be characterized by a normal map. A normal map is a representation of the surface normals of a three-dimensional (3D) model from a particular viewpoint, stored in a two-dimensional colored image, also referred to as an RGB (for example red color/green color/blue color) image. Herein each color corresponds to the orientation of the surface normal.

Yet another way to represent an object is a lighting map. In a lighting map, each point (pixel) represents the intensity of the light shining on the object at said point.

Yet another way to represent an aspect of the object is a binary mask of the object. A binary mask of an object describes its contour, ignoring heights and depths of said object.

Still another way to represent an aspect of the object is a UV map. UV mapping is the 3D modelling process of projecting a 2D image to a 3D model's surface for texture mapping.

All these representations are referred to as “modalities” in the context of the present application. Each of the modalities is extracted from the same base, for example a plurality of features that are encoded in for example a feature vector or a feature map.

Note that the present method is not limited to the specific modalities mentioned above. In principle, any representation may be taken, as long as it may simply be generated from the input models, for example the CAD models.

One underlying task of the described embodiments is to train a network to recognize objects when only texture-less CAD models are available for training. The approach is to first train a generation network to convert cluttered images into clean geometrical representations, that may be used as input for a recognition network that is trained on recognizing objects from such clean geometrical representations. The geometrical representations are also referred to as representations from the synthetic domain.

Examples of such representations are normal maps, depth maps or even a UV map.

The representations should be “clean”, for example they should not contain any clutter.

The representations should further be discriminative, that means that the representation should contain all the information needed for the task, but, if possible, no more.

Advantageously, the representations are also suited to be regressed from the input domain, for example from cluttered images. For instance, it is possible to train a network to regress normal or depth maps from images of an object, as it may use the prior CAD knowledge and the contours of the object to guide the conversion. It might be much harder to regress a representation completely disconnected to the object's appearance, as it is for example the case for blueprints.

Embodiments discloses a novel generative network. The network is relatively complex but yields accurate normal maps from the cluttered input images. The network may be described as a “multi-task auto-encoder with self-attentive distillation”. The network includes the following components:

The generation network includes an encoder sub-network that is configured for extracting meaningful features from the input cluttered images.

The generation network includes several decoders. Each decoder gets the features from the encoder and includes for a task to “decode” the features into a different modality. For instance, one decoder includes a task to extract/recover a normal map from the given features, one decoder includes a task to extract/recover a depth map, one decoder includes a task to extract/recover the semantic mask, one decoder includes a task to extract/recover a lighting map, etc.). By training the decoders together, the network is made more robust, compared to just taking the normal map that is generated in one of the decoders. This is due to synergy as the several decoders are optimized together. This “forces” the encoder to extract as meaningful features as possible that may be used for all tasks.

The generation network includes a distillation sub-network (that is in the following interchangeably also referred to as “distillation module” or “distillation network”) on top of all the decoders. Although one decoder outputting the normal map might seem to be sufficient, the quality of the generative network may be further improved by considering the outputs of the other decoders, too. For instance, the decoder returning the normal map may have failed to properly recover a part of the object, while the depth decoder succeeded. By correlating the results of both decoders, a refined (in other words, “distilled”) normal map may be obtained. The correlation of the individual outputs of the several decoders is carried out by the distillation network. It takes for input the results of the decoders, processes the results together, and returns a refined normal map.

This distillation module makes use of “self-attentive” layers, that help evaluating the quality of each intermediary results to better merge them together. Training the target decoder along others already improves its performance by synergy. However, one may further take advantage of multi-modal architectures by adding a distillation module on top of the decoders, merging their outputs to distil a final result.

Given a Feature Map

x∈ [symbol] ^{C×H×W}

the output of the self-attention operation may exemplarily be:

xₛₐ=x+γ·σ((W_{f}*x)^{T}·(W_{g}*x))·(Wₕ*x)

with σ the softmax activation function;

W_{f}∈ [symbol] ^{C̅×C},W_{g}∈ [symbol] ^{C̅×C},Wₕ∈ [symbol] ^{C×C}

learned weight matrices (it is opted for C̅=C/8); and γ a trainable scalar weight.

Instantiating and applying this process to each re-encoded modality, the resulting feature maps are summed up, before decoding them to obtain the final output.

The new distillation process not only allows to pass messages between the intermediary modalities, but also between distant regions in each of them. The distillation network is trained jointly with the rest of the generator, with a final generative loss L_{g} applied to the distillation results. Not only the whole generator may thus be efficiently trained in a single pass, but no manual weighing of the sub-task losses is needed, as the distillation network implicitly covers it. This is advantageous, as manual fine-tuning is technically possible only when validation data from target domains are available.

Advantages of the present method are:

Fully taking advantage of the synthetic data (usually considered as a poor substitute to real data), by generating all the different modalities for multi-task learning. Applying the multi-task network to “reverse” domain adaptation (for example trying to make real data look synthetic, to help further recognition). Combining together several individual architectural modules for neural networks (for example using self-attention layers for the distillation module).

The cluttered images that are given as input to the generation network are obtained from an augmentation pipeline. The augmentation pipeline augments normal or depth maps into a color image by adding clutter to the clean input map. In addition, information is lost as the output of the augmentation pipeline is a two-dimensional color image instead of a precise 3D representation of the object as input of the augmentation pipeline. The clean normal or depth map of the object may, for instance, be obtained from a CAD model being available of the object.

The generative network as described above may be used in a method to recover objects from cluttered images.

“Recovering” an object is to be understood as recognizing the class of the object (sometimes also referred to as the “instance” of the object), its pose relative to the camera, or other properties of the object.

The method for recovering an object from an unseen real cluttered image includes the following steps: Generating a representation from the synthetic domain from the cluttered image by a generation network that has been trained according to one of the methods described above; Inputting the representation from the synthetic domain into a recognition network, wherein the recognition network has been trained to recover objects from representations from the synthetic domain; Recovering the object from the representation from the synthetic domain by the recognition network; and Outputting the result to an output unit.

The generative network may be used in combination with a known recognition network. The only requirement of the recognition network is that it has been trained on the discriminative synthetic domain (for example, the normal map) that the generative network outputs.

As the method of training the generative network is in practice carried out on a computer, embodiments also include a corresponding computer program product and a computer-readable storage medium.

### BRIEF DESCRIPTION OF THE FIGURES

FIG. 1 depicts a method of recovering the class of an object from an unseen real color image using a generative network according to an embodiment.

FIG. 2 depicts the recovery process in an abbreviated manner according to an embodiment.

FIG. 3 depicts an embodiment of the generative network in more detail.

### DETAILED DESCRIPTION

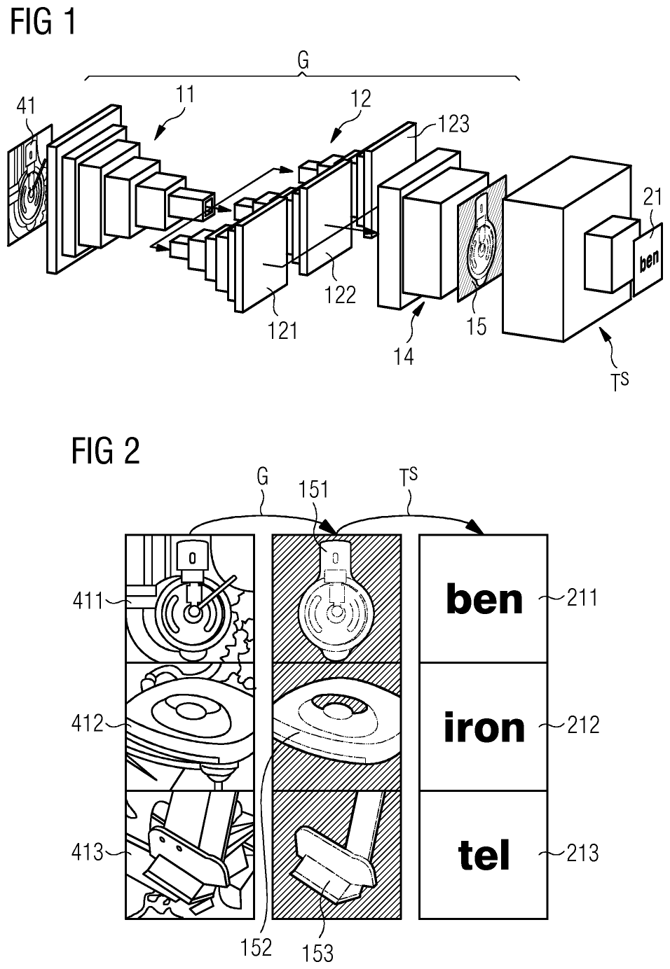

FIG. 1 depicts an embodiment of the method of recovering a certain feature of an object from an unseen real cluttered image 41. The method is depicted by depicting the generative network G and the task-specific recognition network T^{s}, including the corresponding input and output data.

The generative network G includes one encoder 11, several (here: three) decoders 12 and a distillation network 14. The generative network G receives a real cluttered image 41 and maps it into the synthetic domain. In the example shown in FIG. 1, the generative network G returns, for instance, a normal map 15. The normal map 15 is subsequently fed into a recognition network T^{s}. The recognition network is arranged to make a task-specific estimation regarding a predefined property of the object that is depicted in the normal map.

One task for the recognition network may be to tell which one of a set of predetermined objects is actually depicted in the normal map (for example, a cat). This task is also referred to as “object classification”.

Another exemplary task for the recognition network might be to evaluate whether the cat is shown from the front, the back or from the side. This task is also referred to as “pose estimation”.

Yet another task for recognition networks might be to determine how many cats are actually depicted in the image, even if they partially mask, for example occlude each other. This task is also referred to as “object counting”.

Yet another common exemplary task for a recognition network might be to merely detect objects (single or multiple) on an image, for example by defining bounding boxes. This task is also referred to as “object detection”.

Thus, the difference between object classification and object detection is that object detection only identifies that there is any object depicted in the image, while the object classification also determines the class (or instance) of the object.

In the example shown in FIG. 1, the task of the recognition network T^{s} is to classify the object. Here, the recognition network T^{s} correctly states that the object is a bench vise (hence, abbreviated by “ben”).

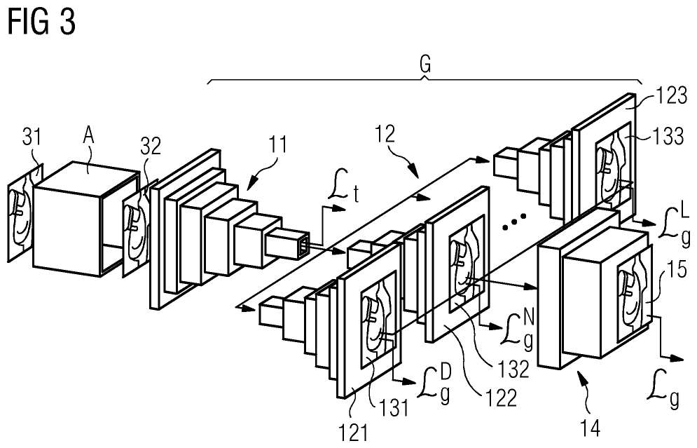

The decoder includes three individual entities, for example a first decoder sub-network 121, a second decoder sub-network 122 and a third decoder sub-network 123. All three decoder sub-networks 121-123 receive the same input, for example the feature vector (or feature map, as the case may be) that has been encoded by the encoder 11. Each decoder sub-network 121-123 is an artificial neural network and converts the feature vector into a predefined modality, that will be described and exemplified in more detail in the context of FIG. 3.

FIG. 2 condenses the pipeline of FIG. 1. The left column relates to the real domain and represents three real cluttered color images, for example a first one depicting a bench vise (first real cluttered image 411), a second image depicting an iron (second real cluttered image 412) and a third image depicting a telephone (third real cluttered image 413). The real cluttered images 411-413 are converted into clean normal maps by the generation network G. “Clean” normal maps refer to the fact that the objects as such have been successfully segmented from the background. As it is common with normal maps, the orientation of the normal at the surface of the object is represented by a respective color. The normal maps are depicted in the middle column of FIG. 2 (for example, by the first normal map 151, the second normal map 152 and the third normal map 153).

The output data of the generation network G (for example the normal maps 151-153) are taken as input for the recognition network T^{s}. The task of the recognition network T^{s} in the example of FIG. 2 is the classification of objects. Thus, the recognition network T^{s} returns as results a first class 211 “bench vise” (abbreviated by “ben”), a second class 212 “iron” and a third class 213 “telephone” (abbreviated by “tel”).

FIG. 3 depicts the generative network G and, in addition, an augmentation pipeline A that generates (synthetic) augmented data from synthetic input data. The augmented data, that are actually cluttered color images, act as training data for the generation network G.

The synthetic input data of the augmentation pipeline A are synthetic normal maps 31 in the example shown in FIG. 3. Alternatively, synthetic normal maps 31 may also be taken as synthetic input data of the augmentation pipeline A.

The synthetic normal maps 31 may be obtained from texture-less CAD models of the objects to be recovered by the recognition network. A “texture-less” CAD model is understood as a CAD model that only contains pure semantic and geometrical information, but no information regarding for example its appearance (color, texture, material type), scene (position of light sources, cameras, peripheral objects) or animation (how the model moves, if this is the case). It will be one of the tasks of the augmentation pipeline to add random appearance or scene features to the clean normal map of the texture-less CAD model. Texture information includes the color information, the surface roughness, and the surface shininess for each point of the object's surface. Note that for many 3D models some parts of the objects are only distinguishable because of the changes in the texture information is known for each point of the object's surface.

Hence, recognition of the objects from cluttered color images are obtained by only reverting to texture-less CAD models of the objects to be recovered.

FIG. 3 also depicts three decoder sub-networks exemplarily in more detail. A first decoder sub-network 121 is configured to extract a depth map 131 from the feature vector provided from the encoder 11; a second decoder sub-network 122 is configured to extract a normal map 132; and a third decoder sub-network 123 is configured to extract a lighting map 133. Although the “task” of the generative network G to return a normal map from the feature vector is in principle already achieved by the second decoder sub-network 122 alone, combining and correlating the results of several sub-networks leads to a more accurate and more robust result. Thus, by virtue of the distillation sub-network 14, a “refined” normal map 15 is obtained. This is achieved among others by optimizing together the respective losses of the intermediary maps, for example L_{g}^{D} for the depth map 131, L_{g}^{N} for the normal map 132 and L for the lighting map 133. Optionally, a triplet loss Lt directly applied to the feature vector returned from the encoder 11 may be included, too.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A Method to train a generation network configured for converting cluttered images from a real domain into a representation from a synthetic domain, the generation network comprising an artificial neural network, the method comprising:
receiving a cluttered image as input,
extracting a plurality of features from the cluttered image by an encoder sub-network,
decoding the plurality of features into a first modality by a first decoder sub-network,
decoding the plurality of features into at least a second modality that is different from the first modality, by a second decoder sub-network,
correlating the first modality and the second modality by a distillation sub-network, and
returning a representation from the synthetic domain as output,
wherein the first modality or the second modality is a depth map, a normal map, a lighting map, a binary mask, or a UV map,
wherein the artificial neural network of the generation network is trained by optimizing the encoder sub-network, the first decoder sub-network, the second decoder sub-network and the distillation sub-network together.

2. The Method of claim 1, wherein the representation from the synthetic domain is without any clutter.

3. The Method of claim 1, wherein the representation from the synthetic domain is a normal map, a depth map or a UV map.

4. (canceled)

5. The Method of claim 1, wherein the distillation sub-network comprises a plurality of self-attentive layers.

6. The Method of claim 1, wherein the cluttered image received as input is obtained from a computer-aided design model that is augmented to a cluttered image by an augmentation pipeline.

7. A Generation network for converting a cluttered image into a representation of a synthetic domain, wherein the generation network is an artificial neural network comprising
an encoder sub-network configured for extracting a plurality of features from the cluttered image given as input to the generation network,
a first decoder sub-network configured for receiving the plurality of features from the encoder sub-network, decoding the plurality of features into a first modality,
at least a second decoder sub-network configured for receiving the plurality of features from the encoder sub-network and decoding the plurality of features into a second modality that is different from the first modality, and
a distillation sub-network configured for correlating the first modality and second modality and outputting a representation of the synthetic domain,
wherein the first modality or the second modality is a depth map, a normal map, a lighting map, a binary mask, or a UV map.

8. A Method to recover an object from a cluttered image by an artificial neural network, the method comprising:
generating a representation of a synthetic domain from the cluttered image by a generation network that is trained to convert cluttered images from a real domain into a representation from a synthetic domain,
inputting the representation of the synthetic domain into a task-specific recognition network, wherein the task-specific recognition network is trained to recover objects from representations of the synthetic domain,
recovering the object from the representation of the synthetic domain by the task-specific recognition network, and
outputting the recovered object to an output unit.

9. (canceled)

10. (canceled)

11. (canceled)

12. The generation network of claim 7, wherein the representation from the synthetic domain is without any clutter.

13. The generation network of claim 7, wherein the representation from the synthetic domain is a normal map, a depth map, or a UV map.

14. The generation network of claim 7, wherein the distillation sub-network comprises a plurality of self-attentive layers.

15. The method of claim 8, wherein the representation from the synthetic domain is without any clutter.

16. The method of claim 8, wherein the generation network is trained by
receiving a cluttered images input,
extracting a plurality of features from the cluttered image by an encoder sub-network,
decoding the plurality of features into a first modality by a first decoder sub-network,
decoding the plurality of features into at least a second modality that is different from the first modality, by a second decoder sub-network,
correlating the first modality and the second modality by a distillation sub-network, and
returning a representation from the synthetic domain as output,
wherein the generation network is trained by optimizing the encoder sub-network, the first decoder sub-network, the second decoder sub-network, and the distillation sub-network together.
